(19) United States
(12) Patent Application Publication
(10) Pub. No.: US 2010/0325295 A1
(43) Pub. Date: Dec. 23, 2010

(54) COMMUNICATION APPARATUS

(76) Inventors: Takatoshi KAJIWARA, Yokohama (JP); Yuuji Koogo, Yokohama (JP); Makoto Arai, Fujisawa (JP); Norihiro Kambe, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/814,658

(22) Filed: Jun. 14, 2010

(30) Foreign Application Priority Data
Jun. 17, 2009 (JP) 2009-143865

(51) Int. Cl. G06F 15/16

(52) U.S. Cl. 709/229; 709/238

(57) ABSTRACT

In a general connection service using the PPPoE protocol, since user determination cannot be performed before a PPP authentication phase, even when a connection request is received from an invalid user, an access server and an authentication server operate under loaded conditions. Accordingly, an invalid user list is held in the access server, and user information is added to a PADI packet. In this arrangement, an invalid user can be determined at early stages and the packet can be deleted, thereby the load can be reduced. Further, regarding the invalid user, pseudo-connection completion is made and an occurrence of retry is prevented, thereby the load can be reduced.

### CLAIM OF PRIORITY

The present application claims priority from Japanese patent application serial no. 2009-143865, filed on Jun. 17, 2009, the content of which is hereby incorporated by reference into this application.

### BACKGROUND OF THE INVENTION

The present invention relates to a communication apparatus, and more particularly, to a PPPoE terminal apparatus having an authentication function.

As an Internet connection service, a connection service using point to point protocol over Ethernet (PPPoE) disclosed in RFC 2516 “A method for Transmitting PPP Over Ethernet (PPPoE)” is widely known. An increasing number of users utilize a method for PPPoE connection, as disclosed in RFC 2516, of performing PPPoE connection using a broadband router and allocating an Internet protocol (IP) address with dynamic host configuration protocol (DHCP) to each host terminal.

Many broadband routers are multi-account type routers to hold plural pieces of account information. Further, some of the broadband routers have account information in their initial state.

When new account information is registered while account information registered in the initial state is not deleted, or when the new account information is registered upon transition to an Internet service provider (ISP), the new account information may be registered without deletion of the old account information. In such case, many users perform connection while invalid account information is left in their broadband routers.

When a broadband router in which plural pieces of account information can be set is used, the user can obtain an Internet service as long as at least one the plural pieces of registered account information is in a normal state. Accordingly, the user does not notice the registered invalid account information and unconsciously leave the invalid information abandoned.

The broadband router tries Internet connection with all the registered account information. The connection fails with the invalid account information. However, as the broadband router performs retry periodically. That is, in Internet connection, invalid connection processing is repeated.

With popularization of broadband routers, broadband routers with registered invalid account information are increasing. Accordingly, ISPs receive and process authentication requests with invalid account information. As a result, loads on a PPPoE terminal access server such as a broadband access server (BAS) and an authentication server such as a remote authentication dial in user service (RADIUS) server are increasing. The ISPs find it necessary to install a device having a higher performance than their primary connection performance.

In a general PPPoE service, authentication is performed by password authentication protocol (PAP) or challenge handshake authentication protocol (CHAP).

In the RAP/CHAP authentication protocol, user information is obtained after the completion of link control protocol (LCP) negotiation. The resources of the access server are consumed before the completion of LCP negotiation. Further, since the access server generally does not hold user information, it transmits an authentication request to the authentication server and receives a connection rejection response from the authentication server. It is impossible for the access server to determine whether the user information is invalid until the connection rejection response is received. Accordingly, the access server transmits an authentication request to the authentication server even when the user information is invalid. As a result, the load on the authentication server is increased.

### SUMMARY OF THE INVENTION

The present invention has been made in consideration of the above situation, and provides a communication apparatus to reduce loads on an access server and an authentication server with respect to an invalid connection request from a user.

The communication apparatus according to the present invention includes: an interface between a router device and a server device; a processor; a program storage unit that holds a first program for PPP protocol processing and a second program for determination of an invalid user; and an invalid user list table that holds the invalid user information, wherein the processor reads the first program and processes a PADI packet received from the router device and a PADO packet transmitted to the router device, then reads the second program and performs retrieval in the invalid user list table regarding user information included in the PADI packet, and, when the user information exists in the invalid user list table, transmits the PADO packet to the router device.

The communication apparatus according to the present invention includes: an interface between a router device and a server device; a processor; a program storage unit that holds a first program for PPP protocol processing and a second program for determination of an invalid user; and an invalid user list table that holds the invalid user information, wherein the processor reads the first program and processes a PADI packet received from the router device and a PADO packet transmitted to the router device, reads the second program and performs retrieval in the invalid user list table regarding user information included in the PADI packet, and, when the user information exists in the invalid user list table, allocates an IP address to the invalid user and establishes a session with the router device.

It may be arranged such that a connection rejection response from the authentication server is monitored with the access server and a list of invalid user information is held in the access server. Upon reception of an invalid connection request, the load on the authentication server can be reduced by performing connection rejection without transmitting an authentication request to the authentication server.

Further, when user information is added to a PPPoE PADI packet, determination of valid/invalid user can be made at early stages, thereby the load on the access server can be reduced.

Further, when a connection request from an invalid user is terminated in the access server and retry connection from the broadband router is not permitted, the loads on the access server and the authentication server can be reduced.

Since the loads on the access server and the authentication server with respect to an invalid connection request can be reduced, the required performances of the access server and the authentication server can be lowered, and economization of capital investment can be realized.

### BRIEF DESCRIPTION OF THE DRAWINGS

Preferred embodiments of the present invention will now be described in conjunction with the accompanying drawings, in which;

FIG. 1 is a block diagram showing a configuration of an access server;

FIG. 2 is a block diagram showing a system configuration;

FIG. 3 is a sequence diagram showing connection processing among a BRT, the access server and an authentication server;

FIGS. 4A to 4D are tables showing a format of a PADI packet;

FIG. 5 is a table showing a data structure of an authentication failure counter;

FIG. 6 is a table showing a data structure of an invalid user determination threshold value;

FIG. 7 is a table showing a data structure of an invalid user list;

FIG. 8 is a flowchart in the access server when an authentication failure response is received from the authentication server;

FIG. 9 is a flowchart in the access server when a PADI packet is received; and

FIG. 10 is a sequence diagram showing the connection processing between the BRT and the access server.

### DETAILED DESCRIPTION OF THE PREFERRED EMBODIMENTS

Hereinbelow, exemplary embodiments will be described in detail using the drawings.

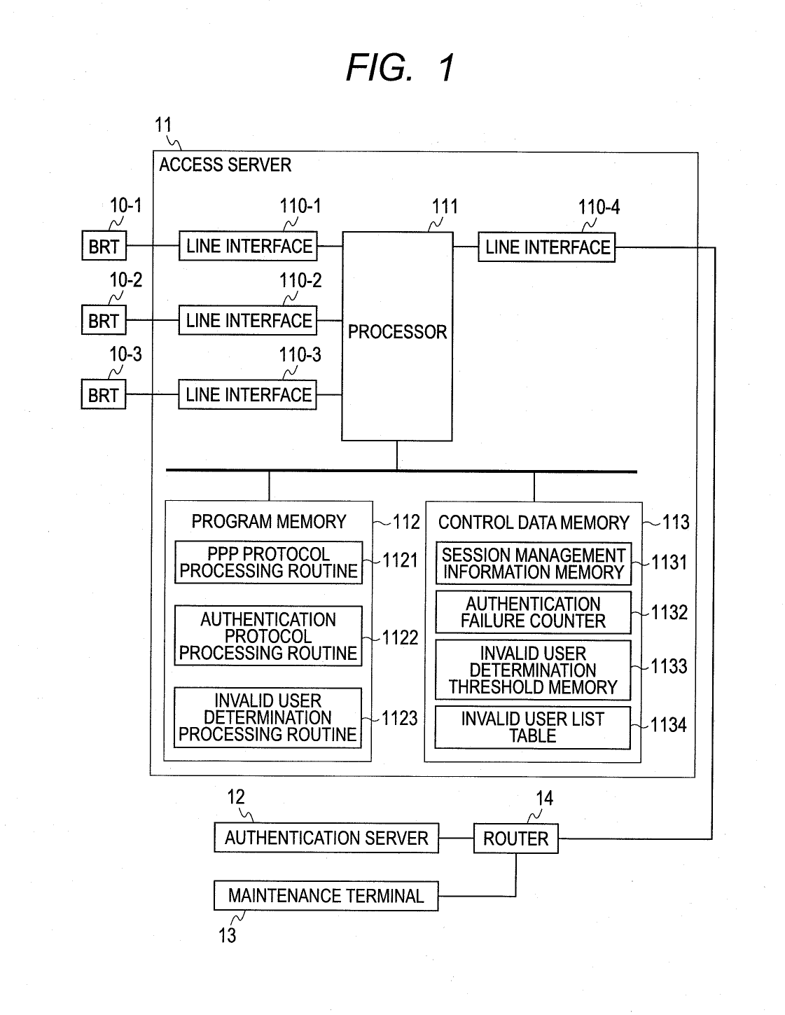

FIG. 1 shows a configuration of an access server.

An access server 11 has broadband routers (BRT) 10-i (i=1, 2 . . . ) as router devices, line interfaces 110-i (i=1, 2 . . . ) for connection with an authentication server 12, a processor 111 for program processing, a program memory 112 for storage of programs, and a control data memory 113 for storage of data. The program memory 112 holds software having functions of a PPP protocol processing routine 1121, an authentication protocol processing routine 1122, and an invalid user determination processing routine 1123. The control data memory 113 has areas of a session management information memory 1131, an authentication failure counter 1132, an invalid user determination threshold memory 1133 and an invalid user list table 1134.

The access server 11 is connected via the line interface 110-4 to a router 14. The access server 11 performs communication via the router with the authentication server 12 and a maintenance terminal 13.

A connection request from the BRT 10-i (i=1, 2 . . . ) is processed with the PPP protocol processing routine 1121. The access server 11 manages identification and session state of each BRT 10-i (i=1, 2 . . . ) as session management information in the session management information memory 1131.

The access server 11 performs authentication processing upon connection request with the authentication protocol processing routine 1122. The authentication protocol processing routine 1122 performs communication with the authentication server 12 and performs authentication processing.

Upon authentication processing, when a rejection response is returned from the authentication server 12, the access server 11 counts the number of authentication failures with the authentication failure counter 1132. When the value of the authentication failure counter 1132 exceeds an invalid user determination threshold value stored in the previously-set invalid user determination threshold memory 1133, the access server 11 registers the BRT as invalid user information in the invalid user list table 1134.

Regarding the BRT 10-i (i=1, 2 . . . ) registered in the invalid user list, upon the next connection request, the access server 11 performs processing with the invalid user determination processing routine 1123. That is, the access server 11 rejects connection without performing the authentication processing with respect to the authentication server 12.

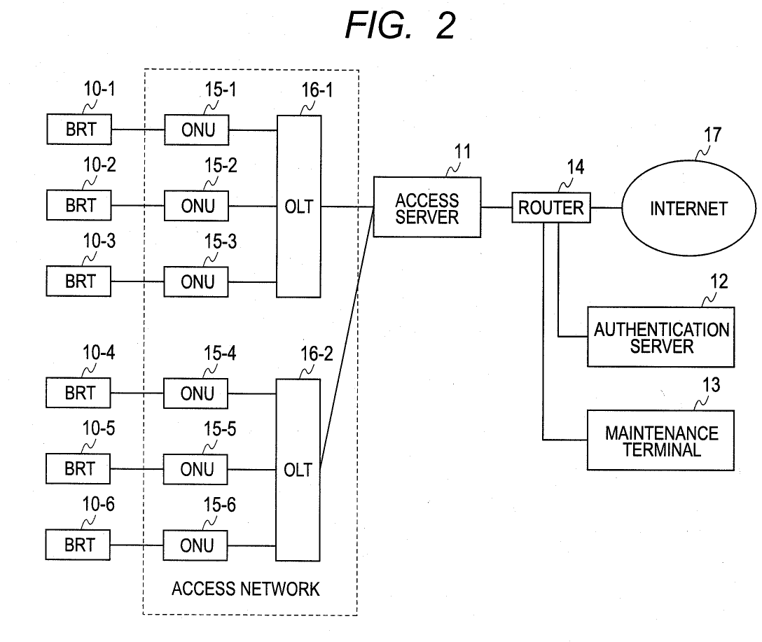

FIG. 2 shows a system configuration.

The BRT 10-i (i=1, 2 . . . ) is integrated at an optical line terminal (OLT, a terminal device on the management side) 16-i (i=1, 2 . . . ) via an optical network unit (ONU, a terminal device on the subscriber side) 15-i (i=1, 2 . . . ) and is connected to the access server 11. The access server 11 is connected to the authentication server 12 and the maintenance terminal 13 via the router 14. The access server 11 terminates the PPPoE/PPP of the BRT 10-i (i=1, 2 . . . ). The access server 11 supplies connection to the Internet 17 via the router 14 to the BRT 10-i.

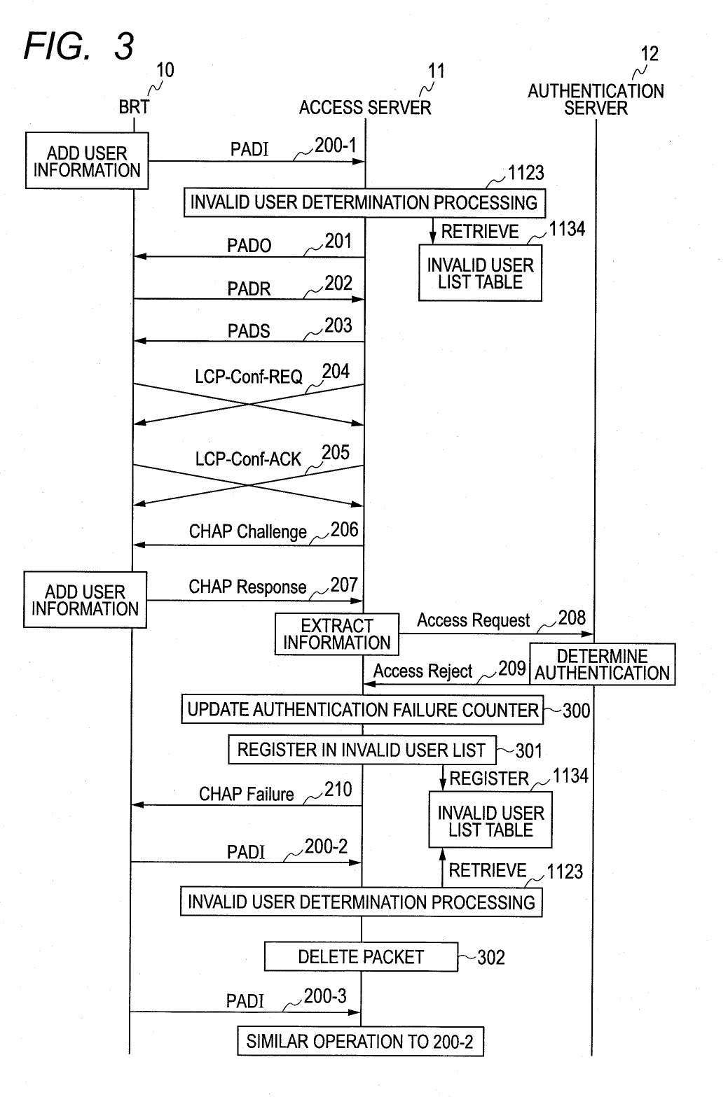

FIG. 3 shows a protocol sequence. In FIG. 3, the CHAP protocol is used as an authentication method, and the RADIUS protocol is used as a protocol between the access server and the authentication server.

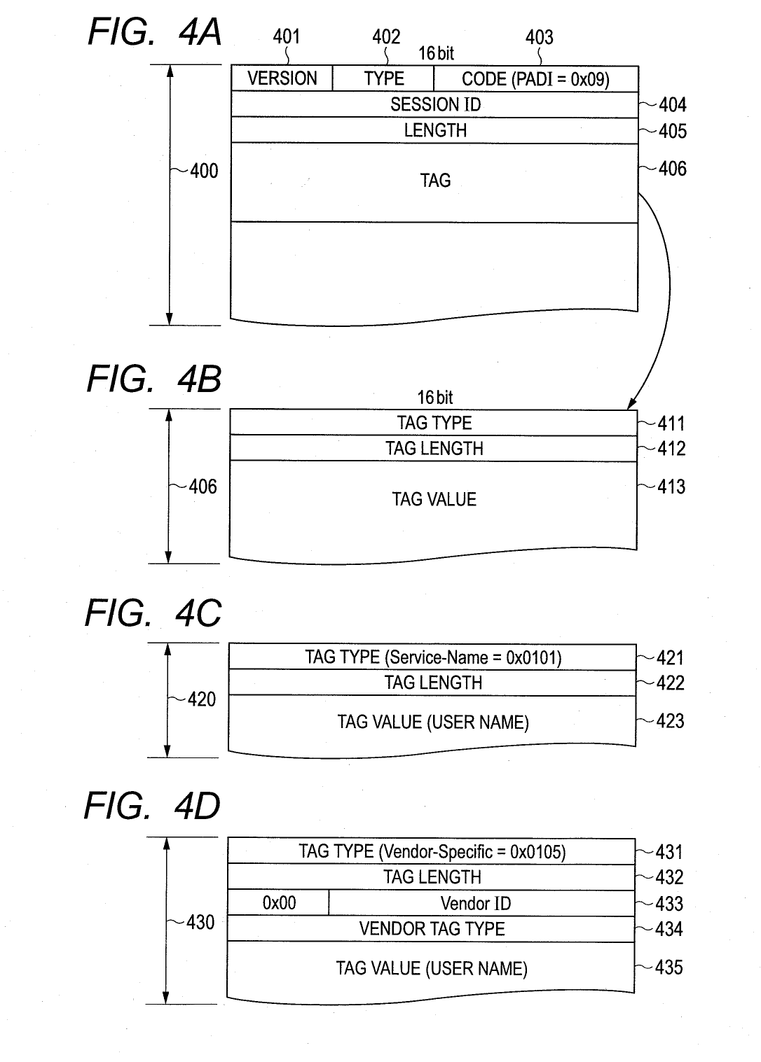

The BRT 10 adds user information to a PADI packet 200-1 and transmits it to the access server 11. The details of the PPPoE active discovery initiation (PADI) packet will be descried in FIGS. 4A to 4D later.

The access server 11 receives the PADI packet 200-1, then performs retrieval in the invalid user list 1134 with the invalid user determination processing 1123. Since there is no corresponding user information, the access server 11 returns a PPPoE active discovery offer (PADO) packet 201. Thereafter, the BRT 10 and the access server 11 exchange a PPPoE active discovery request (PADR) packet 202, a PPPoE active discovery session-confirmation (PADS) packet 203, an LCP-Configuration-Request packet 204, an LCP-Configuration-Ack packet 205, and enter an authentication phase.

In the authentication phase, the access server 11 transmits a CHAP-Challenge packet 206. The BRT 10 receives the CHAP-Challenge packet 206, then adds the user information to a CHAP-Response packet 207 and transmits the packet. The access server 11 receives the CHAP-Response packet 207, then reads necessary information from the CHAP-Response packet 207 and the session management information 1131, and generates an Access-Request packet 208. The access server 11 transmits the Access-Request packet 208 to the authentication server 12.

The authentication server 12 receives the Access-Request packet 208, then performs authentication determination from the user information. The authentication server 12 returns an authentication result. Since the authentication is rejected in this example, the authentication server 12 transmits an Access-Reject packet 209. The access server 11 receives the Access-Reject packet 209, then updates the authentication failure counter 1132. The access server 11 determines whether or not the counter value exceeds a threshold value stored in the invalid user determination threshold memory 1133. In this example, since the counter value exceeds the threshold value, the access server 11 registers the BRT in the invalid user list table 1134. Further, the access server 11 transmits a CHAP-Failure packet 210 to the BRT 10.

The BRT 10, which has not established connection due to the authentication failure, adds the user information to a PADI packet 200-2 and transmits the packet so as to perform the connection sequence again. The access server 11 receives the PADI packet 200-2, then performs retrieval in the invalid user list table 1134 and determines that corresponding user information is registered. The access server 11 deletes the PADI packet 200-2. Hereinafter, the PADI packet 200-i (i=3 . . . ) from the BRT 10 is deleted, therefore the loads on the access server 11 and the authentication server 12 can be reduced.

FIGS. 4A to 4D show the format of the PADI packet.

In FIG. 4A, a PPPoE packet 400 has a version field 401, a type field 402, a code field 403, a session ID field 404 for session identification, a length field 405 indicating the length of the PPPoE packet, and a 0 or more TAG information 406. In FIG. 4B, the TAG information 406 has a TAG type field 411 indicating the type of the tag (TAG), a TAG length field 412 indicating the length of the TAG, and a TAG value field 413 storing a TAG value.

As a PADI packet, a value 0x09 indicating the PADI packet is set in the code field 403. Note that a user account name used upon ISP authentication as user information is stored as a user name in the TAG.

When a Service-Name tag is used as a TAG for storage of user name, as in the case of a Service-Name tag 420 in FIG. 4C, a value 0x0101 is stored in the TAG type 421, the tag length is stored in the TAG length 422, and a user name is stored in the TAG value field 423.

FIG. 4D shows the format of a Vendor-Specific tag 430 when a Vendor-Specific tag is used as a TAG for storage of user name. Note that the Vendor-Specific tag 430 has an arbitrary format, therefore the format is not limited to that shown in the figure. A value 0x0105 is stored in the TAG type 431, the tag length is stored in the TAG length 432, and a vendor-ID is stored in the Vendor-ID field 433. A vendor tag type 434 is information for identification of a subsequent field. A TAG value field 435 holds a user name. In this manner, user information is added in the PADI packet, thereby the user name can be identified by the access server upon reception of the PADI packet.

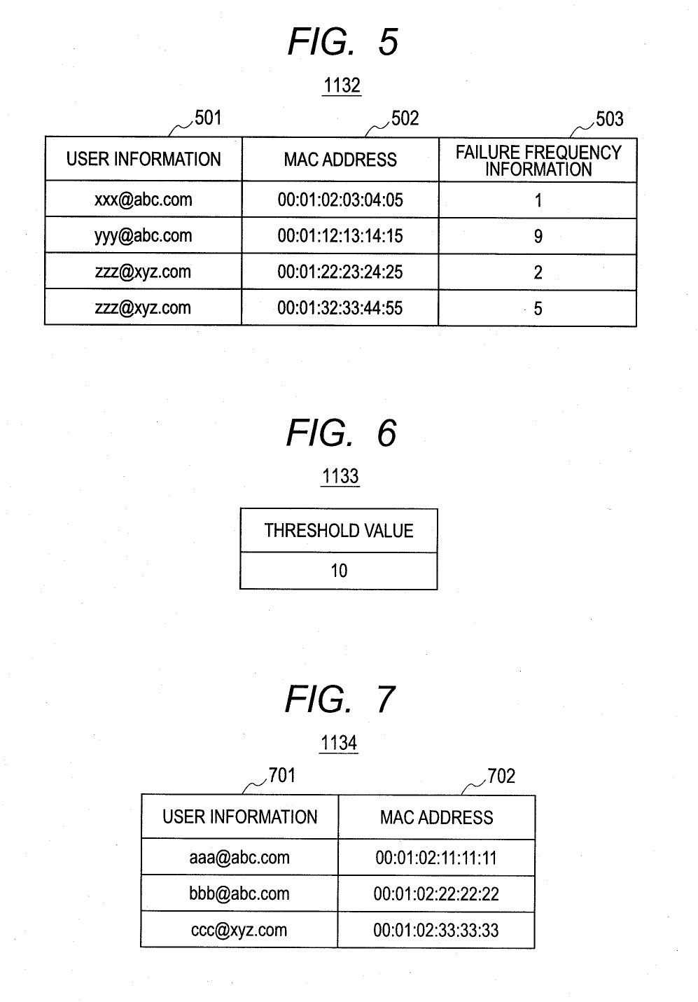

FIG. 5 shows a data structure of the authentication failure counter 1132.

The authentication failure counter 1132 holds user information 501, a MAC address 502 of the BRT 10, and failure frequency information 503. The access server 11, having a counter for user information corresponding to a user to whom an authentication failure response is returned from the authentication server 12, counts the number of authentication failures and records the count result. When identification of the BRT 10 is not performed, the MAC address (identification information of a terminal connected to a router) 502 may be omitted. When the MAC address is added, the identification of the BRT 10 can be exactly performed.

FIG. 6 shows a data structure of the invalid user determination threshold memory 1133.

The invalid user determination threshold memory 1133 holds a lower limit number of authentication failures for registration of an authentication-failure user managed with the authentication failure counter 1132 in the invalid user list table 1134.

FIG. 7 shows a data structure of the invalid user list table 1134.

The invalid user list table 1134 holds a combination of user information 701 of a user determined as an invalid user and a MAC address 702 of the BRT 10 in a list. Note that as in the case of FIG. 5, the MAC address may be omitted.

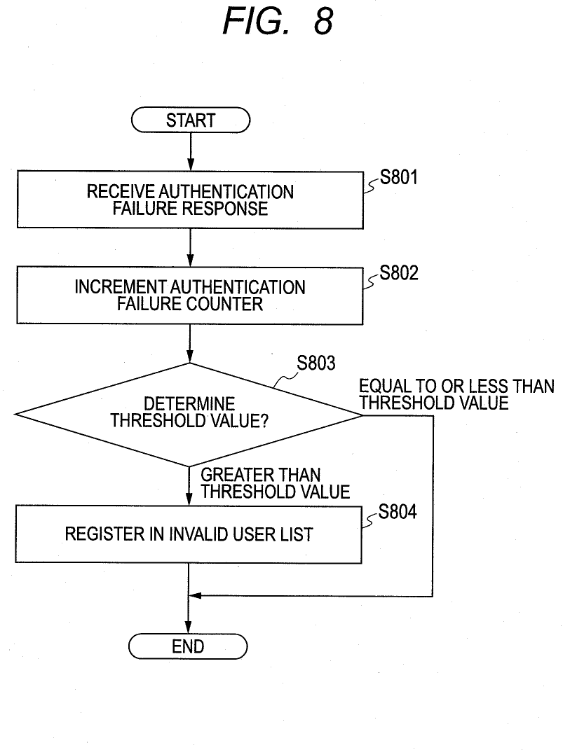

FIG. 8 is a flowchart when an authentication failure response is received from the authentication server 12. The access server 11, upon receiving an authentication failure response from the authentication server 12 (S801), increments the authentication failure counter 1132 corresponding to user information regarding which the authentication has failed (S802).

The access server 11 determines whether or not the number of failures exceeds the threshold value 1133 in the invalid user determination threshold memory as a result of increment (S803). When the number of failures exceeds the threshold value, the access server 11 registers the user information of the corresponding user in the invalid user list table 1134 (S804). When the number of failures is equal to or less than the threshold value, the access server 11 does not perform the registration in the invalid user list and the process ends.

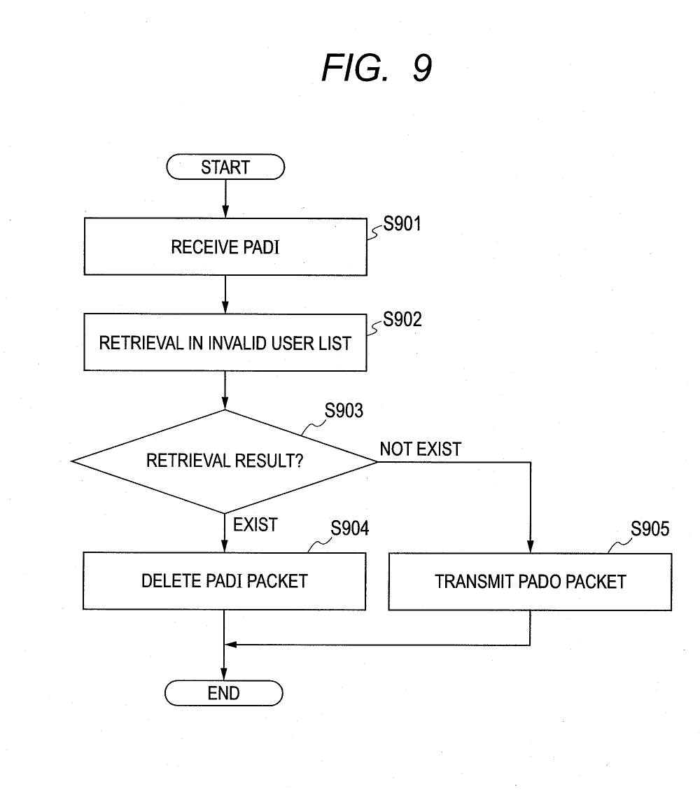

FIG. 9 is a flowchart showing processing upon reception of a PADI packet.

When a PADI packet is received (S901), the access server 11 performs retrieval in the invalid user list with user information in the PADI packet (S902). Thereafter, the access server 11 determines the result of retrieval in the invalid user list table (S903). When a corresponding user exists in the invalid user list table 1134, the access server 11 deletes the PADI packet (S904), and the process ends. When no corresponding user exists in the invalid user list table 1134, the access server 11 edits a PADO packet, transmits the PADO packet (S905), and the process ends.

By using the above method, the determination of an invalid user can be performed upon reception of a PADI packet, and the loads on the access server 11 and the authentication server 12 can be reduced.

Note that the invalid user list table may be corrected/managed/display-checked with maintenance operations at the maintenance terminal. Further, the access server, upon registering an invalid user in the invalid user list table, may transmit a registration notification to the maintenance terminal. When these functions are adopted, a maintenance person can easily manage invalid user statuses.

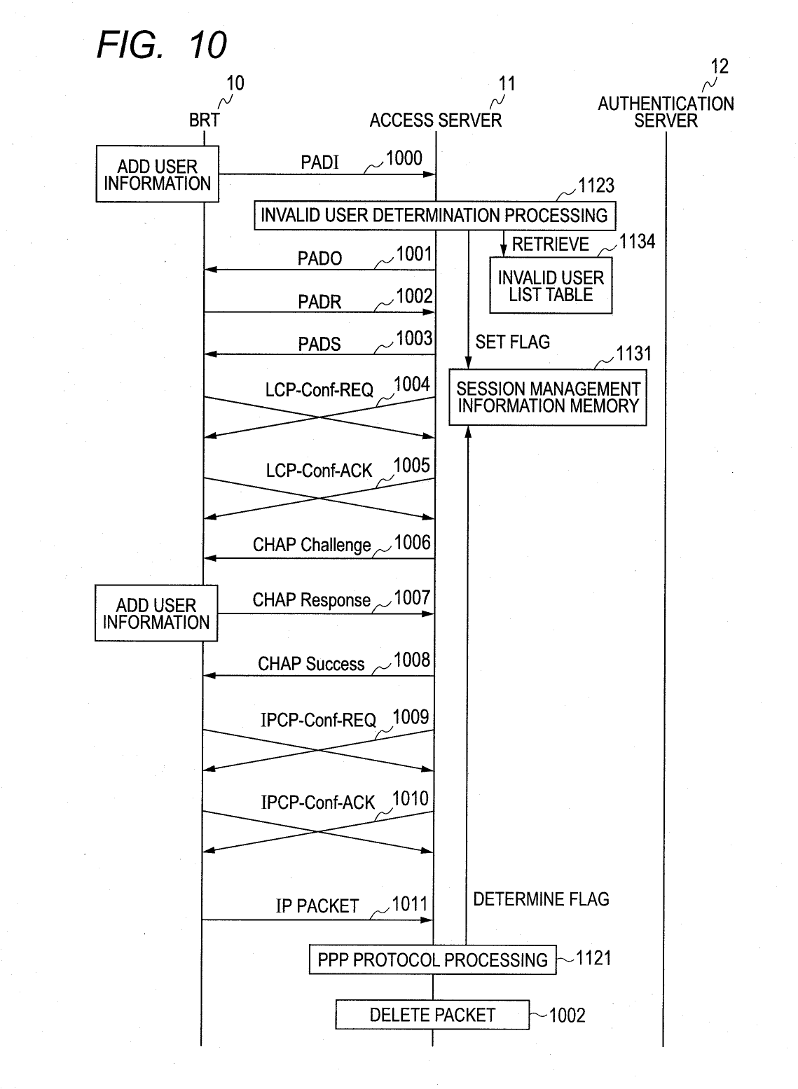

FIG. 10 is a sequence diagram according to another embodiment.

In FIG. 10, the user of the BRT 10 is already registered in the invalid user list table 1134. The sequence before the registration in the invalid user list table 1134 is the same as that shown in FIG. 3.

When a PADI packet 1000 to which user information is added is received from the BRT 10, the access server 11 performs retrieval in the invalid user list 1134. When a corresponding user is registered in the invalid user list 1134, the access server 11 adds an invalid user flag to the session management information memory 1131.

Thereafter, the BRT 10 and the access server 11 exchange a PADO packet 1001, a PADR packet 1002, a PADS packet 1003, an LCP-Configuration-Request packet 1004, and an LCP-Configuration-Ack packet 1005, and enter the authentication phase.

In the authentication phase, the access server 11 transmits a CHAP-Challenge packet 1006 to the BRT 10. The BRT 10 receives the CHAP-Challenge packet 1006, then adds the user information to a CHAP-Response packet 1007 and transmits the packet. The access server 11 receives the CHAP-Response packet 1007, then responds to the BRT 10 with a CHAP-Success packet 1008 without transmitting an authentication request to the authentication server 12. After the authentication phase, an IPCP-Configuration-Request packet 1009, an IPCP-Configuration-Ack packet 1010 are exchanged, and a PPP session is established.

At this time, an IP address added to the IPCP-Configuration-Request packet 1009 from the access server 11 is not a regular IP address but an IP address allocated to an invalid user. As the IP address allocated to an invalid user, one of available IP addresses other than IP addresses allocated to regular users is designated.

After the establishment of the PPP session, when the BRT 10 transmits an IP packet 1101, during encapsulation release processing on the PPP encapsulated packet with the PPP protocol processing routine 1121, existence/absence of invalid user flag added to the session management information is determined. When it is determined that the invalid user flag is set, the access server 11 does not transfer the packet but deletes the packet.

By the above-described processing, no retry occurs regarding a connection request from an invalid user, and reduction of the loads on the access server 11 and the authentication server 12 can be realized.

What is claimed is:

1. A communication apparatus comprising:
an interface between a router device and a server device;
a processor;
a program storage unit that holds a first program for PPP protocol processing and a second program for determination of an invalid user; and
an invalid user list table that holds the invalid user information,
wherein the processor reads the first program and processes a PADI packet received from the router device and a PADO packet transmitted to the router device, reads the second program and performs retrieval in the invalid user list table regarding user information included in the PADI packet, and, when the user information exists in the invalid user list table, transmits the PADO packet to the router device.

2. The communication apparatus according to claim 1, wherein, when the PADO packet is transmitted to the router device and then a new PADI packet is received, the new PADI packet is deleted.

3. A communication apparatus comprising:
an interface between a router device and a server device;
a processor;
a program storage unit that holds a first program for PPP protocol processing and a second program for determination of an invalid user; and
an invalid user list table that holds the invalid user information,
wherein the processor reads the first program and processes a PADI packet received from the router device and a PADO packet transmitted to the router device, reads the second program and performs retrieval in the invalid user list table regarding user information included in the PADI packet, and, when the user information exists in the invalid user list table, allocates an IP address to the invalid user and establishes a session with the router device.

4. The communication apparatus according to claim 2, wherein, when the session is established and an IP packet is received from the router device, the IP packet is deleted.

5. The communication apparatus according to claim 1, further comprising:
a counter for management of the number of user authentication failures; and
a third program stored in the program storage unit for the user authentication,
wherein the processor reads the third program and processes the user authentication based on information included in the packet from the router device,
the counter counts the number of authentication failures, and
the invalid user list table holds the user information of the user regarding whom the number of times of authentication failures exceeds a threshold value, as the user information of the invalid user.

6. The communication apparatus according to claim 3, further comprising:
a counter for management of the number of user authentication failures; and
a third program stored in the program storage unit for the user authentication,
wherein the processor reads the third program and processes the user authentication based on information included in the packet from the router device,
the counter counts the number of authentication failures, and
the invalid user list table holds the user information of the user regarding whom the number of times of authentication failures exceeds a threshold value, as the user information of the invalid user.

7. The communication apparatus according to claim 1, wherein the user information includes a user account.

8. The communication apparatus according to claim 3, wherein the user information includes a user account.

9. The communication apparatus according to claim 1, wherein the user information includes a user account and identification information of a terminal connected to the router device.

10. The communication apparatus according to claim 3, wherein the user information includes a user account and identification information of a terminal connected to the router device.

11. The communication apparatus according to claim 1, wherein communication is performed with the router device based on the PPPoE protocol.

12. The communication apparatus according to claim 3, wherein communication is performed with the router device based on the PPPoE protocol.

13. The communication apparatus according to claim 5, wherein when the user information of the invalid user is stored in the invalid user list table, a registration notification is transmitted to the outside.

14. The communication apparatus according to claim 6, wherein when the user information of the invalid user is stored in the invalid user list table, a registration notification is transmitted to the outside.
